(19) United States
(12) Patent Application Publication
(10) Pub. No.: US 2007/0148285 A1
(43) Pub. Date: Jun. 28, 2007

(54) CONFECTIONERY PRODUCTS HAVING LIQUID CENTERS

(76) Inventor: Marguerite Yang, Wilmette, IL (US)

Correspondence Address: BELL, BOYD & LLOYD LLP, P.O. Box 1135, CHICAGO, IL, 60690, US

(21) Appl. No.: 11/566,960

(22) Filed: Dec. 5, 2006

Related U.S. Application Data
(60) Provisional application No. 60/749,780, filed on Dec. 12, 2005.

(51) Int. Cl. A23G 4/18

(52) U.S. Cl. 426/5

(57) ABSTRACT

Confectionery products comprising liquid centers and methods for making same are provided. In an embodiment, the present invention provides a confectionery product comprising a confectionery shell surrounding at least one liquid filled bead.

### PRIORITY CLAIM

This application claims the benefit of U.S. Provisional Patent Application Ser. No. 60/749,780 filed on Dec. 12, 2005, the entire disclosure of which is hereby incorporated.

### BACKGROUND

The present invention relates generally to confectionery products. More specifically, the present invention relates to confectionery products having unique liquid centers and methods regarding the same.

There are numerous types of confectionery products having a liquid center. Such confectionery products can include, for instance, chewing gum or candy. Confectionery products having a liquid center that are sold through commercial distribution channels should have an acceptable shelf-life. However, due to the liquid center, the outer confectionery shell may pick up moisture and change in texture and flavor due to the moisture migration between the liquid center and the outer confectionery casing. This can lead to the loss of optimum texture and taste. In addition, confectionery shells surrounding a liquid center may not be uniform in thickness or may have defects or openings, which can result in liquid leaking out from the confectionery product during production and storage.

It is desirable to produce a confectionery product having a liquid center that has greater stability and control with respect to moisture and structural stability. Therefore, there is a need to provide improved confectioneries having a liquid center.

### SUMMARY

The present invention relates to improved confectionery products having liquid centers. For example, in an embodiment, the present invention provides a confectionery product comprising a confectionery shell surrounding one or more liquid filled beads. In an embodiment, the bead comprises a preformed edible casing surrounding a liquid center.

In an embodiment, the bead includes a coating surrounding the bead.

In an embodiment, the bead coating comprises at least one component selected from sugars, polyols, shellac, zein, lipids, gelling agents and combinations thereof.

In an embodiment, the casing comprises at least one component selected from gelatins, pectins, hydrocolloids, cellulose gums, modified starches, crosslinked starches and combinations thereof.

In an embodiment, the liquid center comprises at least one ingredient selected from malted products, sweeteners, flavors, colors, sensates, acids, medicaments, actives and combinations thereof.

In an embodiment, the confectionery shell can be a confectionery material such as, for example, chewing gum, powder, liquid, paste, candy, fat-based confectionery, crystallized pastes, pressed tablets, solid foam, shear thickening fluid, rework or combinations thereof.

In an embodiment, the candy can be selected from hard boiled candy, chewy candy, caramel, taffy, fondant, chocolate, compound coating, jelly, fruit leather, gummy, glassy, crystalline, nougat, licorice and combinations thereof.

In an embodiment, the water content of the confectionery shell ranges from about 0.01% to about 20%.

In an embodiment, the confectionery shell can be coated.

In an embodiment, the shell coating comprises at least one component selected from sugars, polyols, shellac, zein, lipids, gelling agents and combinations thereof.

In another embodiment, the present invention provides a confectionery product comprising a confectionery shell surrounding at least one liquid filled bead, wherein a coating surrounds at least one of the liquid filled bead and the confectionery shell. For example, the coating can provide a rigidity to prevent the liquid filled bead and/or the confectionery shell from deforming.

In an alternative embodiment, the present invention provides a confectionery product comprising a confectionery shell surrounding at least one liquid filled bead, wherein a coating surrounds at least one of the liquid filled bead and the confectionery shell. The coating can provide a barrier to control moisture migration between the bead and the confectionery shell due to hydrophobic and/or hydroscopic characteristics. For example, coatings used as hydrophobic barriers can include shellac, zein, or lipids such as butter fat or cocoa fats.

The coating can also provide a barrier to control oil migration between the bead and the confectionery shell due to lipophobic characteristics. For example, coatings used as lipophobic barriers can include sugars, polyols and/or gelling agents. Interior coatings used as lipophobic carriers can include, for example, combinations of sugars or polyols and water or gelling agents and water.

In an alternative embodiment, the present invention provides a confectionery product comprising a confectionery shell surrounding at least one liquid filled bead, wherein the liquid filled bead comprises a preformed edible casing surrounding a liquid center. The liquid center, edible casing and confectionery shell can each have a water content or water activity that causes water migration among the liquid center, edible casing and confectionery shell. For example, the liquid center, edible casing and confectionery shell each have a texture that changes due to the water migration.

In another embodiment, the present invention provides a confectionery product comprising a confectionery shell surrounding at least one liquid filled bead, wherein the liquid filled bead comprises a preformed edible casing surrounding a liquid center. The liquid center, edible casing and confectionery shell can each have an oil content that causes oil migration among the liquid center, edible casing and confectionery shell. For example, the liquid center, edible casing and confectionery shell each have a texture that changes due to the oil migration.

In an alternative embodiment, the present invention provides a method of making a confectionery product. For example, the method comprises providing one or more liquid filled beads and surrounding the beads with a confectionery material.

In an embodiment, the method comprises providing a coating on the prior to surrounding the beads with the confectionery material.

In another embodiment, the present invention provides a method of making a confectionery product. For example, the method comprises depositing at least one liquid filled bead into a mold and adding a confectionery material to the mold to surround the bead.

In an alternative embodiment, the present invention provides a method of making a confectionery product. For example, the method comprises adding a plurality of liquid filled beads to an extruder along with a confectionery material; extruding the confectionery material including the beads; and cutting the confectionery material including the beads into pieces with each piece having at least one bead.

In another embodiment, the present invention provides a method of making a confectionery product. For example, the method comprises providing at least one liquid filled bead and encasing the bead in a confectionery material.

In an alternative embodiment, the present invention provides a method of making a confectionery product. For example, the method comprises premixing at least one liquid filled bead and confectionery material to form a confectionery mixture; and depositing the confectionery mixture into a mold, onto a belt and combinations thereof.

An advantage of the present invention is to provide a confectionery having a unique center fill.

Another advantage of the present invention is to provide a liquid filled confectionery that has reduced moisture migration between the liquid center and confectionery shell.

Yet another advantage of the present invention is to provide a confectionery having a liquid center that has controlled moisture migration between the adjacent confectionery layers.

Still another advantage of the present invention is to provide an improved process for making a liquid filled confectionery.

Moreover, an advantage of the present invention is to provide a liquid filled confectionery having an improved flavor burst as the confectionery is being chewed.

Additional features and advantages are described herein, and will be apparent from, the following Detailed Description and the Figures.

### BRIEF DESCRIPTION OF THE FIGURES

FIG. 1 illustrates a cross-section view of the bead in one embodiment of the present invention.

FIG. 2 illustrates a cross-section view of the confectionery product in one embodiment of the present invention.

FIG. 3 illustrates a cross-section view of the confectionery product in another embodiment of the present invention.

### DETAILED DESCRIPTION

The present invention relates to improved confectionery products. More specifically, the present invention relates to improved confectionery products having liquid centers and methods for making same.

In the present specification, the term “shell” should be understood to mean a confectionery material such as, for example, a chewing gum or candy that surrounds a bead. The candy can be, for example, any suitable confectioneries capable of forming the shell. The confectionery material comprising the shell is distinguishable from a film layer or coating layer as understood by the skilled artisan.

In the present specification, the term “bead” should be understood to mean an edible container or casing that encloses a liquid material. The casing of the bead can be made, for example, from any suitable gelatins, pectins, hydrocolloids, cellulose gums, modified and/or crosslinked starches and combinations thereof that form casing compositions which are capable of holding the enclosed liquid. The liquid within the bead can be a water or oil based liquid. The water or oil based liquid can further include any suitable amount of additional ingredients such as, for example, malted products, sweeteners, flavors, colors, sensates, acids, medicaments, actives, etc.

In the present specification, the term “water or oil based liquid” should be understood to mean compositions having any amount of water or oil, respectively. For example, the water or oil based liquid can be in the form of syrups, solutions, emulsions, suspensions, pastes, gels, etc. Further, the water or oil based liquid can contain additional materials such as, for instance, particulates, crystals, particles, nonpareils, smaller beads, etc. The particulates may be, for example, confectionery pieces, vegetable pieces, fruit pieces and/or particulates of sugar, polyols, gum or any other suitable food products. Any of the layers (including the center) can contain swirl patterns and/or semi-random non-homogenous fluid components, for example, non-concentric circular layers.

In the present specification, the term “coating” should be understood to mean a covering or layer of a material spread over a surface, for example, by using a coating syrup. In embodiments of the present invention, a coating can be applied to the surface of the bead or the surface of the confectionery shell or both. For example, the coating layer can be used for protection, decoration, taste, etc. In addition, the coating layer can act a barrier to prevent or control water or oil migration through the coating layer. It should be appreciated that the coatings and confectionery shells as used herein are distinct components in embodiments of the present invention.

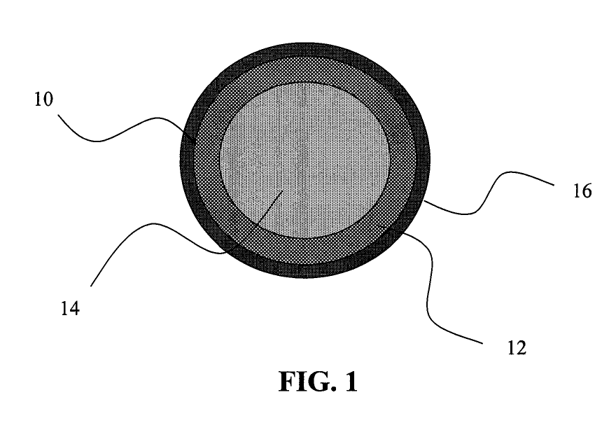

In an embodiment illustrated in FIG. 1, a liquid filled bead 10 comprises a container or casing 12 surrounding a liquid center 14. For example, the liquid filled bead 10 can have a preformed casing 12 surrounding the liquid center prior to being surrounded by a confectionery shell.

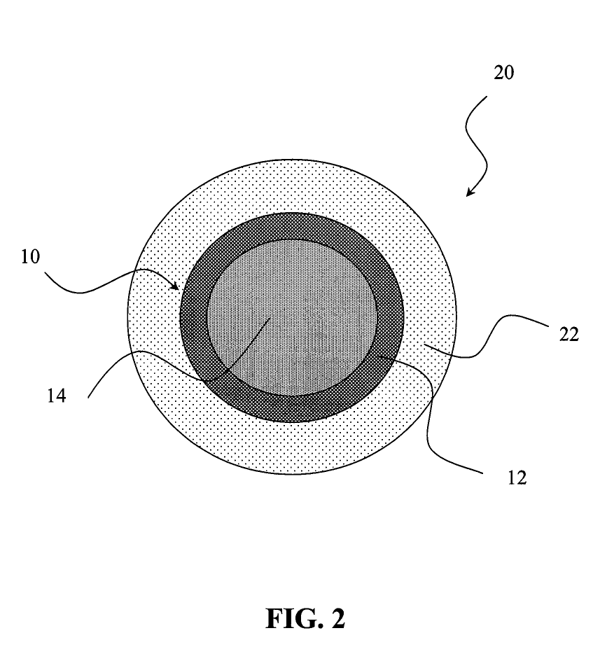

In another embodiment illustrated in FIG. 2, the present invention provides a confectionery product 20 comprising a confectionery shell 22 surrounding at least one liquid filled bead 10. The confectionery shell 22 can be any suitable confectionery material such as, for example, chewing gum, powder, liquid, paste, candy, fat-based confectionery, crystallized pastes, pressed tablets, solid foam, shear thickening fluid, rework or combinations thereof. It should be appreciated that rework may include, for example, ancillary and reusable confectionery trim, scrap and other non-virgin material made during the confectionery manufacturing processes as understood by the skilled artisan. The confectionery shell can comprise materials that are genetically modified organism (GMO) free.

The candy can be, for example, hard boiled candy, chewy candy, caramel, taffy, fondant, chocolate, compound coating, jelly, fruit leather, gummy, glassy, crystalline, nougat, licorice or other suitable confectioneries. If the confectionery shell comprises chocolate, then the bead may include a protective coating.

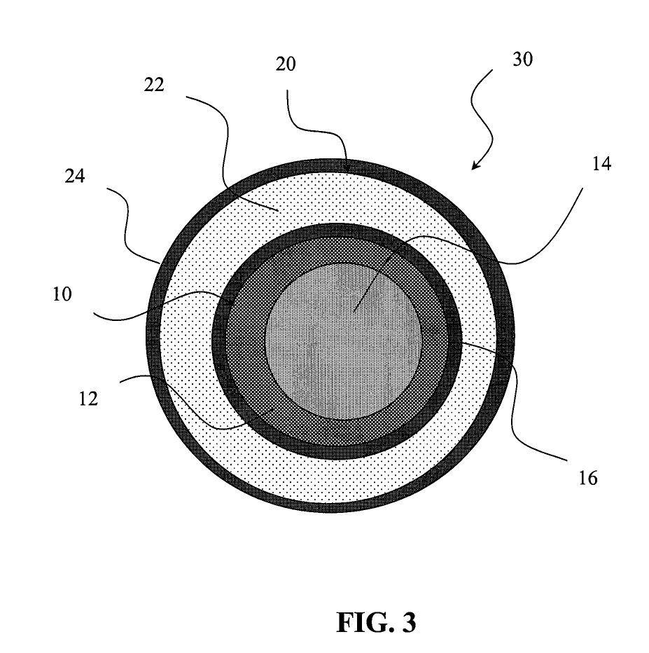

In an alternative embodiment illustrated in FIG. 3, the present invention provides a confectionery product 30 comprising a confectionery shell 22 surrounding at least one liquid filled bead 10. The liquid filled bead 10 includes a coating 16 that acts, for example, as a moisture or oil barrier between the liquid filled bead 10 and the confectionery shell 22. The confectionery shell 22 can be any suitable confectionery such as a chewing gum, a candy or combinations thereof as previously described.

It should be appreciated that the confectionery products in embodiments of the present invention can be any suitable size or shape such as, for example, a pellet, sphere, cube, cigarette, spiral etc. The liquid filled beads can also be any suitable size or shape. The confectionery shells can have any suitable thickness.

As illustrated in embodiments in FIGS. 1 and 3, the casing 12 of the bead 10 can be coated with any suitable coating material 16 such as, for example, sugars, polyols or combinations thereof to form a crystalline or glassy coating around the casing 12. For example, one or more bead coatings 16 can be applied to the surface of the liquid filled bead 10 prior to the bead 10 being surrounded by the confectionery shell 22. The sugar or polyols can be, for example, a component of a syrup or spray that is applied to the bead coating 16. This crystalline or glassy coating can serve to control water or oil migration between the center bead 10 and the confectionery shell 22. It should be appreciated that the bead coating 16 can be applied to the bead 10 by any suitable coating method such as, for example, spraying, panning, etc.

The bead coating can provide a number of additional benefits to the bead. For example, the bead coating can give physical crush/compression strength to the bead thereby reducing its deformity and breakage characteristics. The bead coating can give heat stability to the beads as the casing can be usually made of materials having low melting characteristics. The bead coating can provide protection/barrier to control or prevent flavor, oil and/or moisture migration between the confectionery shell and the bead along with its liquid contents. In addition, the bead coating can also provide the bead with a flavor burst as the liquid center confectionery product is being chewed. The benefits that derive from the bead coating also allow a greater range of materials that can be suitably used for the edible casing of the bead.

In an embodiment illustrated in FIG. 3, one or more external coatings 24 can be applied to the exterior of the confectionery product 20 by spraying, panning or any suitable coating process. For example, the external coating 24 can be used to prevent or control moisture from the environment into the confectionery product 20. In this manner, the external coating 24 can be applied to the entire confectionery product and may or may not comprise the same ingredients as material used for the bead coating. It should be appreciated that the coatings (along with any other confectionery material) can be applied to the beads or confectionery shells by any suitable coating method such as, for example, spraying, panning, bath, curtain, etc.

Optionally, flavors may be separately sprayed onto the beads or confectionery shells during the coating process to provide a flavored coating. Optionally, a final polishing coat may be applied to the pieces after the coatings have been applied. The polishing coat may use a wax, such as carnauba wax, or shellac. It may also include fillers such as talc and colors.

The confectionery shell may also comprise texture changing ingredients that can partially or entirely liquefy the layer over time. Such ingredients may include, for example, acids like lactic acid, malic acid, citric acid and phosphoric acid and enzymes like amylases and proteinases.

It should be appreciated that the liquid center, bead casing, confectionery shell and/or coating can comprise one or more ingredients such as, for example, malted products, flavors, sensates, colors (e.g. azo free colors), sweetener, acids, actives and medicaments (e.g. listed below). Alternatively, the ingredients can be in the form of encapsulation, compaction, granulation and agglomeration to provide, for example, protected and longer-lasting ingredient components such as flavors and sensates. It should also be appreciated that any or all of the layers (e.g. liquid center, bead casing, confectionery shell and/or coating) can comprise any suitable number and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dextrin, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

Combinations of sugar and/or sugarless sweeteners may be used in the confectionery. If a low calorie confectionery is desired, a low caloric bulking agent can be used. Example of low caloric bulking agents include: polydextrose; Raftilose; Raftilin; Fructooligosaccharides (NUTRAFLORA®); Palatinose oligosaccharide; Guar Gum Hydrolysate (SUN FIBER®); or indigestible dextrin (FIBERSOL®). However, other low calorie bulking agents can be used.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2diol, menthol, spearmint, N-ethyl-p-menthane-3-carboxamide, N,2,3-trimethyl-2-isopropyl-butanamide, menthyl glutarate, menthol PG carbonate, menthol EG carbonate, menthol glyceryl ether, 3,3,5-trimethylcyclohexanol, and isopulegol.

Non-limiting examples of heating agents may include capsicum oleoresin, capsaicin, piperine, gingerol, shoagol, ginger oleoresin, cinnamon oleoresin, and cassia oleoresin, black pepper oleoresin, pepper oleoresin, vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same.

Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

In an embodiment, the present invention provides methods for making a confectionery product by providing one or more liquid center-filled beads and partially or entirely surrounding the beads with a confectionery shell material. By way of example and not limitation, the beads (with or without a coating) can be deposited in a mold where gum or other confection can be added to the mold around the bead. Alternatively, one or more beads can be added to an extruder and extruded with a confectionery material. The extruded rope may have beads throughout it. The extruded rope can be cut into pieces with each piece having at least one bead. The beads can also be wrapped or encased in a chocolate, compound coating, or a boiled or cooked candy material such as, for example, caramel or glassy candy. Alternatively, beads can by mixed into a confectionery material, and the confectionery material containing the beads can be portioned or deposited.

The confectionery products can be sheeted, stamped, pressed, rolled and/or printed on. Particulates can be added, for example, to the external surface of the products via dropping, dusting, conveying, tumbling, dragging, stamping and/or hand applying.

The confectionery shell 22 can having any suitable water (e.g. moisture) or oil content or level. For example, the water or oil content of the confectionery shell may be set at a level that dissolves the bead coating or casing over time during storage. The water or oil content can also be at a level where the bead coating or casing remains intact or substantially intact during storage.

Though the coatings on the bead casing and/or outer shell can be used to give structure during processing, the coatings can be made to soften so as to not be noticeable during consumption. For example, the moisture or oil content and/or water activities of the liquid centers, bead casings, confectionery shells and coatings can be adjusted so that water and/or oil can migrate between layers after production. As a result, the texture of each layer may or may not change. In an embodiment, the moisture may move to equilibrate water activities between contiguous layers unless there are physical or hydrophobic barrier layers to prevent or control moisture movement (e.g. due to hydrophilicity/hydroscopicity).

Multiple or homogenous textures during consumption may be preferred. The rate of water and/or oil migration can determine how quickly the texture of the confectionery layers (e.g. coating layer, confectionery shell layer, bead casing layer or liquid center layer) changes over time upon processing and during post-processing. Water and/or oil migration between layers can be prevented and/or promoted by controlling the water/oil levels and/or water activities (Aw) of each layers. For example, water and oil migration between adjacent confectionery layers may be greater if the differences of the water/oil levels and/or water activities of each layer are large. Conversely, water and oil migration between adjacent confectionery layers may be insubstantial or not occur at all if the differences of the water/oil levels and/or water activities of each layer are similar or the same.

Alternatively, a confectionery barrier layer may be used to control water/oil migration between layers. For example, hydrophobic barriers or layers (e.g. coatings) can be used to prevent, limit or control moisture migration. Coatings used as hydrophobic barriers can include shellac, zein, or lipids such as butter fat or cocoa fats.

As with water, oil can migrate between layers. For example, higher liquid oil contents can create softer layer textures. Oil may move towards equilibrium between contiguous layers (e.g. due to lipophilicity). Lipophobic barriers or layers (e.g. coatings) can be used to prevent, limit or control oil migration between layers. By way of example and not limitation, coatings used as lipophobic barriers can include sugars, polyols and/or gelling agents. Interior coatings used as lipophobic carriers can include, for example, combinations of sugars or polyols and water or gelling agents and water.

In an alternative embodiment, the confectionery shell 22 can comprise a chewing gum having a water-soluble bulk portion, a water-insoluble chewable gum base portion and typically water-insoluble flavoring agents. For example, the water-soluble portion dissipates with a portion of the flavoring agent over a period of time during chewing. The gum base portion can be retained in the mouth throughout the chew.

A variety of chewing gum formulations can be used to create the shell 22. The chewing gum can comprise materials that allow it to be suitably combined with other confectioneries. For example, the chewing gum can be chocolate/fat tolerant, acid friendly, tack-free, etc.

Chewing gum generally consists of a water insoluble gum base, a water soluble portion, and flavors. The insoluble gum base generally comprises elastomers, resins, fats and oils, softeners, and inorganic fillers. The gum base may or may not include wax. The insoluble gum base can constitute approximately 5 to about 95 percent, by weight, of the chewing gum shell, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called ester gums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum includes a water soluble bulk portion and one or more flavoring agents. The water soluble portion can include bulk sweeteners, high intensity sweeteners, flavoring agents, softeners, emulsifiers, colors, sensates, acidulants, fillers, antioxidants, preservatives, actives, medicaments (as previously described) and other suitable components or processing aids or combinations thereof that provide desired attributes as known by the skilled artisan.

Softeners can be added to the chewing gum in order to optimize the chewability and mouth feel of the gum. The softeners, which are also known as plasticizers and plasticizing agents, generally constitute between approximately 0.5 to about 15% by weight of the chewing gum. The softeners may, in addition to including caprenin, include glycerin, lecithin, and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

A variety of processes for manufacturing chewing gum are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A confectionery product comprising a confectionery shell surrounding at least one liquid filled bead.

2. The confectionery product of claim 1, wherein the bead comprises a preformed edible casing surrounding a liquid center.

3. The confectionery product of claim 1, wherein the bead comprises a coating surrounding the surface of the bead.

4. The confectionery product of claim 3, wherein the bead coating comprises at least one component selected from the group consisting of sugars, polyols, shellac, zein, lipids, gelling agents and combinations thereof.

5. The confectionery product of claim 4, wherein the casing of the bead comprises at least one component selected from the group consisting of gelatins, pectins, hydrocolloids, cellulose gums, modified starches, crosslinked starches and combinations thereof.

6. The confectionery product of claim 4, wherein the liquid center comprises at least one ingredient selected from the group consisting of malted products, sweeteners, flavors, colors, sensates, acids, medicaments, actives and combinations thereof.

7. The confectionery product of claim 1, wherein the confectionery shell comprises a confectionery material selected from the group consisting of chewing gum, powder, liquid, paste, candy, fat-based confectionery, crystallized pastes, pressed tablets, solid foam, shear thickening fluid, rework and combinations thereof.

8. The confectionery product of claim 7, wherein the candy is selected from the group consisting of hard boiled candy, chewy candy, caramel, taffy, fondant, chocolate, compound coating, jelly, fruit leather, gummy, glassy, crystalline, nougat, licorice and combinations thereof.

9. The confectionery product of claim 1, wherein the water content of the confectionery shell ranges from about 0.01% to about 20%.

10. The confectionery product of claim 1, wherein the confectionery shell comprises a coating surrounding the shell.

11. The confectionery product of claim 10, wherein the shell coating comprises at least one component selected from the group consisting of sugars, polyols, shellac, zein, lipids, gelling agents and combinations thereof.

12. A confectionery product comprising a confectionery shell surrounding at least one liquid filled bead, wherein a coating surrounds at least one of the liquid filled bead and the confectionery shell and wherein the coating provides a rigidity to prevent the liquid filled bead or the confectionery shell from deforming.

13. A confectionery product comprising a confectionery shell surrounding at least one liquid filled bead, wherein a coating surrounds at least one of the liquid filled bead and the confectionery shell and wherein the coating provides a barrier to control water migration between the bead and the confectionery shell due to hydrophobic characteristics.

14. A confectionery product comprising a confectionery shell surrounding at least one liquid filled bead, wherein a coating surrounds at least one of the liquid filled bead and the confectionery shell and wherein the coating provides a barrier to control oil migration between the bead and the confectionery shell due to lipophobic characteristics.

15. A confectionery product comprising a confectionery shell surrounding at least one liquid filled bead, wherein the liquid filled bead comprises a preformed edible casing surrounding a liquid center and wherein the liquid center, edible casing and confectionery shell each have a water content or water activity that causes water migration among the liquid center, edible casing and confectionery shell.

16. The confectionery product of claim 15, wherein the liquid center, edible casing and confectionery shell each have a texture that changes due to the water migration.

17. A confectionery product comprising a confectionery shell surrounding at least one liquid filled bead, wherein the liquid filled bead comprises a preformed edible casing surrounding a liquid center and wherein the liquid center, edible casing and confectionery shell each have an oil content that causes oil migration among the liquid center, edible casing and confectionery shell.

18. The confectionery product of claim 17, wherein the liquid center, edible casing and confectionery shell each have a texture that changes due to the oil migration.

19. A confectionery product comprising a confectionery shell surrounding a plurality of liquid filled beads.

20. A method of making a confectionery product, the method comprising:
providing at least one liquid filled bead; and
surrounding the bead with a confectionery material.

21. The method of claim 20, wherein the bead comprises a coating surrounding the surface of the bead.

22. A method of making a confectionery product, the method comprising:
depositing at least one liquid filled bead into a mold; and
adding a confectionery material to the mold to surround the bead.

23. A method of making a confectionery product, the method comprising:
adding a plurality of liquid filled beads to an extruder along with a confectionery material;
extruding the confectionery material including the beads; and
cutting the confectionery material including the beads into pieces with each piece comprising at least one bead.

24. A method of making a confectionery product, the method comprising:
providing at least one liquid filled bead; and
encasing the bead in a confectionery material.

25. A method of making a confectionery product, the method comprising:
premixing at least one liquid filled bead and confectionery material to form a confectionery mixture; and
depositing the confectionery mixture on to an apparatus selected from the group consisting of a mold, a belt and combinations thereof.
